(19) United States
(12) Patent Application Publication
(10) Pub. No.: US 2023/0379699 A1
(43) Pub. Date: Nov. 23, 2023

(54) SECURITY MANAGEMENT OF NETWORKED DEVICES USING A DISTRIBUTED LEDGER NETWORK

(71) Applicant: NXM LABS, INC., Mountain View, CA (US)

(72) Inventors: Kevin John OERTON, Toronto (CA); Kristopher BYRNE, Toronto (CA)

(21) Appl. No.: 18/247,019

(22) PCT Filed: Sep. 28, 2021
(86) PCT No.: PCT/US21/52464

§ 371 Date: Mar. 28, 2023

Related U.S. Application Data
(60) Provisional application No. 63/084,314, filed on Sep. 28, 2020.

(51) Int. Cl. H04W 12/037; H04W 12/37; H04W 12/106

(52) U.S. Cl. CPC H04W 12/037; H04W 12/37; H04W 12/106

(57) ABSTRACT

A blockchain-based system for manages the root of trust for a swarm of deployed devices and maintains separation between the control and data planes of the device network through policies distributed from the blockchain via a message broker system and enforced in the secure processing environment of the devices. The blockchain is operated by a set of stakeholder entities that provide consensus for adding transactions to the blockchain or channels thereof, which comprise attestation data for use by the devices during onboarding, firmware installation and updates, and policy updates. Devices subscribe to message topics on a message broker system to obtain control plane and data plane messages. Access to message topics is managed by rules enforced by the secure processing environment.

This application claims the benefit of and priority from U.S. Provisional Application No. 63/084,314 filed Sep. 28, 2020, the entirety of which is incorporated herein by reference.

### TECHNICAL FIELD

This disclosure relates to security management of networked devices, and in particular to the use of distributed ledger (blockchain) services to deploy and manage the control plane of a network of devices such as Internet of Things (IoT) devices.

### TECHNICAL BACKGROUND

With the proliferation of Internet-enabled (so-called “smart” devices or “Internet of Things” devices), the number of potential attack vectors on home, workplace, industrial, public, and even government networks has increased enormously. Notably, a network of IoT devices in even a simple deployment can include a variety of device types and models manufactured by different vendors, controlled by a variety of applications. In a household environment, dozens of smart devices may be deployed throughout the home, such as smart speakers, thermostats, light fixtures, refrigerators, and the like. The number of deployed devices in an enterprise or organizational context—such as a commercial, school, industrial or government building or campus, smart neighborhood or city, or in any geographic region may number in the thousands. In the context of mobile devices, conventional mobile device security (e.g., mobile device management, mobile application reputation services) may not be suitable for these deployments. Moreover, the security and trustworthiness of any device is dependent on multiple parties who contribute different elements, such as an original equipment manufacturer (OEM), firmware provider, and certification authorities.

### BRIEF DESCRIPTION OF THE DRAWINGS

In drawings which illustrate by way of example only embodiments of the present invention,

FIG. 1 is an illustration of an example networked environment including a blockchain network and a deployed device or data network.

FIG. 2 is a block diagram illustrating select functional components of an example deployed device operating in the environment of FIG. 1.

FIG. 3 is a schematic diagram illustrating an example blockchain channel.

FIG. 4 is an interaction diagram illustrating a possible flow of messages in an onboarding process.

FIG. 5 is a schematic diagram illustrating provisioning of a deployed device and control plane and data plane communications with the device.

### DETAILED DESCRIPTION

The below examples and embodiments provide a networked system and method for implementing and controlling communications in a network of deployed devices 100 using a blockchain-based infrastructure to deploy and manage the control plane of a network of deployed devices. Briefly, the control plane of the device network is defined in transactions added to a blockchain (referred to below as a “distributed ledger”), which are permitted only when endorsed by a sufficient number of participants in the distributed ledger. The distributed ledger network is operated by a consortium of stakeholder entities such as device and component manufacturers (e.g., chips, firmware), certification authorities (e.g., safety, standards, and/or security certification authorities), and deploying enterprises or organizations, and optionally other entities that contribute other elements relevant to the operation of the deployed devices. Each stakeholder entity contributing to consensus or contributing smart contracts (also referred to below as chaincode) for managing or provisioning deployed devices operates one or more endorsing peers in the distributed ledger. Different functions or aspects of the control plane (e.g., security lifecycle, access control, cyber warranties) may be associated with different distributed ledgers or distributed ledger channels, each of which may have a different set of endorsing peers selected from the consortium, depending on the function. Each distributed ledger or distributed ledger channel defines the stakeholder or endorsing peer consensus required to implement a state change to a given digital asset in the network of devices (e.g., firmware authorization, user authorization, messaging channel authorization) through the execution of chaincode. The participation of the endorsing peers in the management of control plane functions may ensure that changes to the control plane are consistent with stakeholder policies, thus maintaining device and system integrity. The organization of control plane functions using distributed ledgers also decentralizes control plane management so as to reduce vulnerability of the device network to attacks on a single point of the network. Additionally, attestation and root of trust information for the deployed devices can be stored on the distributed ledger to guarantee immutability of manufacturer parameters, for use by the deployed devices to renew its security state by, for example, autonomously initiating cryptographic key regeneration.

Some control plane functions are associated with messaging “channels” between deployed devices and other components of the device network. While any suitable messaging paradigm may be employed, a publish-subscribe paradigm, implemented using message brokers, is used in the examples set out below for communication within and between the device network and distributed ledger network. Similarly, many data plane functions (telemetry and actuation or command messages) are also associated with messaging channels using the same publish-subscribe paradigm and message brokers to transmit and receive sensor data and actuation data (device control instructions) between deployed devices, device administrators, and the operator of data plane services (e.g., cloud services, data aggregators). These messaging channels (in the publish-subscribe system used below, “topics”) are defined by the participating endorsing peers of the distributed ledger, and are stored on the distributed ledger. The use of a publish-subscribe mechanism is not necessary; in other implementations, point-to-point communication between devices and other network components may be employed, with messaging channels defined in the point-to-point message structure, such as topic values included in message headers.

The deployed devices may be configured by embedding the security and communication policies, whose state is stored in the distributed ledger peer nodes, in the firmware and trusted applications stored and executed in the device's secure processing environment. The distributed ledger may then be accessed to validate the device firmware and software against the stored information in the distributed ledger. Alternatively, the device can be configured by retrieving the relevant information recorded on the distributed ledger. The device's public keys may also be stored in the distributed ledger, and requests for access by third parties (e.g., other deployed devices, network users, administrators, and cloud services) to these keys is determined through the execution of chaincode on the distributed ledger to validate the requests. Thus, changes to the security state of a deployed device, its configuration, and requests for access to public keys or other information by third parties, can be implemented using the distributed ledger in a transparent and auditable manner.

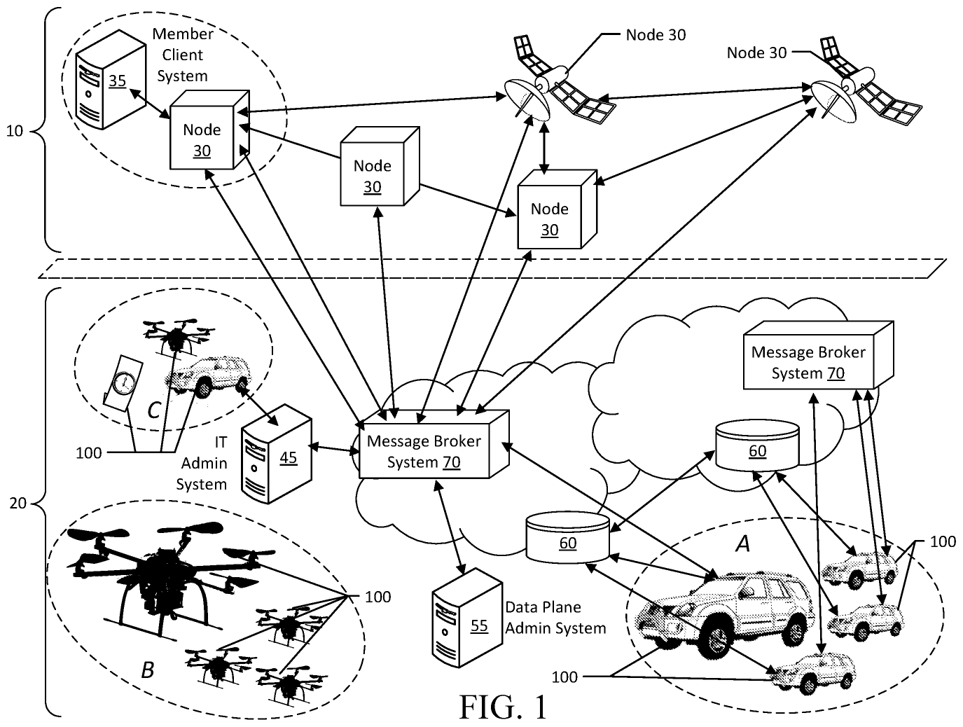

FIG. 1 provides a schematic diagram illustrating select parts of a blockchain or distributed ledger network 10 and deployed device or data network 20 that may be used to implement the examples and embodiments described below. The distributed ledger network 10 is a networked set of computing nodes 30, or peers, each implementing a suitable module for maintaining an instance of a distributed ledger. Appropriate platforms include Hyperledger, available from The Linux Foundation, or Ethereum, which is available from the Ethereum Foundation. Implementations of these platforms include IBM Hyperledger Fabric; Parity Ethereum from Parity Technologies; Hyperledger Sawtooth, a project of Hyperledger hosted by The Linux Foundation); and Infura from ConsenSys Inc. Other appropriate platforms and infrastructures known to the person skilled in the art, including cloud-based and dedicated server-based architectures, may be employed. Selection of one particular platform over another may be determined, at least in part, by the capacity of the infrastructure to handle the anticipated volume of traffic. Selection may also be determined at least in part by a desired consensus algorithm, if any is used (e.g., proof of authority versus proof of work versus proof of stake). If the distributed ledger is private rather than public, a consensus algorithm may not be required. In the examples described below, the distributed ledger is private, with the distributed ledger network operator, who initially establishes the distributed ledger, acting as the gatekeeper for the addition of peers.

In a Hyperledger implementation, the distributed ledger network 10 may include peer systems filling different roles such as orderer, anchor, and endorser peers. The orderer and anchor peers may be in the control of the distributed ledger network operator, or these roles may be assumed by nodes 30 operated by the other stakeholder entities. However, as will be seen below, it is expected that each stakeholder entity will implement at least one endorser peer (also referred to below as an endorsing peer or node), although some entities may not participate as an endorser peer or operate mode, acting only as a client that submits transactions that must be endorsed by the endorser peers. Administrative functions for the node system 30 may optionally be handled using a corresponding administrative computer system 35.

In a Hyperledger implementation, the nodes 30 may also be organized into different distributed ledger channels, each associated with a different control plane function or set of control plane functions, or with a set of access control administrators. In a distributed ledger implementation that does not support channels, individual distributed ledgers may be established instead. In the examples described herein, channels are employed but those skilled in the art will appreciate that the distributed ledger architecture may be modified to omit the use of channels. Organization of channels is described in further detail below. In either case, the distributed ledger network 10 may in fact comprise a plurality of distributed ledgers maintained by different subsets of nodes 30.

The configuration of the distributed ledger nodes 30 will be known to those skilled in the art. The nodes 30 can comprise any suitable computing device equipped with suitable communication subsystems for implementing the functions described below. Further, the distributed ledger nodes 30 need not be limited to terrestrial computing devices. A node 30 may be resident, for example, on an airborne or space craft or a geocentrically orbiting craft, such as a satellite in geosynchronous orbit.

A device or data network 20 is generally indicated in FIG. 1. In this example, the device network 20 comprises distinct clouds or swarms of devices 100 each served by the same cloud based services; but it will be understood by those skilled in the art that the device network 20 need not be implemented using a single cloud network; different device swarms A, B, C may each be served by a distinct cloud network or alternatively a system of dedicated servers and associated networking infrastructure.

In this example, swarms A and B comprise different vehicles. For example, swarm A may be a set of vehicles, independently owned and operated by different users, but participating in a device ecosystem in which telemetry data (e.g., speed, location data) is shared among the devices and with other parties, such as a municipality or manufacturer. Swarm B may be another set of vehicles deployed in a given geographic region by a single operator, such as a government, business or other entity, and the telemetry generated by these vehicles may be accessed only by the operator. Swarm C comprises an assortment of different devices, as might be found in a household under the control of a single user who acts also as the device administrator, or in a commercial or other setting under the control of many users and one or more administrators as represented by IT administrator system 45. For ease of reference in the examples below, rather than refer to distinct entities such as governments, businesses, other organizations, and individual users that may act as the user administration authority for a given device or swarm of devices, these operating entities are referred to generally as the “enterprise”.

Further, in some implementations communication between the device network 20 and the distributed ledger network 10 is brokered by a proxy or gateway service, not shown in FIG. 1, rather than by direct communication between the elements of the device network 100 and the nodes 30; and where feasible, distributed ledger queries are handled by an explorer service to reduce latency in distributed ledger transactions. An example of a proxy or gateway service and explorer service that may be integrated into the examples described herein is described in PCT Publication No. WO2019/213781 published Nov. 14, 2019 which is incorporated herein by reference. While examples set out herein assume that no proxy service or explorer service is used, the inventive concepts of this disclosure encompass use of these services. Suitable modifications to the device and distributed ledger networks to accommodate these services may be implemented by those skilled in the art.

FIG. 1 also depicts a data plane service operating in the device network 20, as represented by the data plane administrator system 55. A data plane service is a service operating on the telemetry delivered by the devices 100 or providing operator control functions for the devices 100. These services may be administered by the device manufacturer, which may also implement a billing system to charge the users or enterprise for data plane services. Data plane services may be cloud-based systems, or alternatively hosted on dedicated server systems. The data plane administrator system 55 permits the administrator or operator of the data plane service to define the services operating on the telemetry data of the devices 100 and to configure communication between the devices 100 and the data plane service. In the example of FIG. 1, this includes communication between deployed devices 100 and a message broker system 70 managed by the data plane administrator or operator.

Generally, communications between deployed devices 100 and data plane services pertain to data services, and therefore reside in the data plane of the operating environment of the deployed device. However, the ability of the deployed devices 100 to access the data plane service and transmit telemetry to the data plane service is determined by the access control rules implemented in the control plane. These rules are also stored and enforced by the secure processing environment of the deployed device 100, and can be updated on the device 100 either as part of a firmware update, or separate from a firmware update. Applications or functions executing on the device 100 to collect telemetry or other device data such as operational commands or device configuration data for transmission in the data plane, may be trusted applications executing in a secure enclave or secure processing environment of the device 100 to reduce the risk of tampering or interception of the device data.

As mentioned above, communications between deployed devices 100 in the data plane, between the devices 100 and distributed ledger node systems 30, and between devices 100 and administrator systems 45, and between devices 100 and data plane service providers 55 may be implemented as either point-to-point or mediated messages. An example of a mediated communication is the use of the publish-subscribe system described above and illustrated in FIG. 1, where messages are received from senders and made available to recipients by message broker systems 70 deployed in the device network 20. In some implementations, the message broker system 70 may be implemented at an edge device (within a device 100). In the example of FIG. 1, broker systems 70 are remote. A single message broker system 70 may handle communications for a single device swarm (e.g., swarm A or B), but in practice different message broker systems 70 may be implemented for different device vendors or manufacturers, since vendors may wish to isolate their device data from others. For a given swarm of devices, multiple broker systems 70 may be deployed in the network 20, for example in different geographic regions to minimize latency.

Each device or node that employs this protocol executes a network client application to publish or retrieve messages from the broker systems 70. On deployed devices, the network client application exchanges the messages with a network management module executing in a trusted execution environment or secure processing environment in the device. The broker systems 70 may be deployed as a cloud-based service, on a dedicated network server or appliance, or, in mesh embodiments discussed below, on deployed devices 10. The configuration of such broker systems 70 will be understood by those skilled in the art. Examples of suitable protocols include, but are not limited to, Message Queueing Telemetry Transport (MQTT), which is a lightweight messaging protocol suitable for devices with less processing capability and/or greater need for power conservation, and more robust protocols such as Advanced Message Queuing Protocol (AMQP). Suitable broker platforms include such as RabbitMQ from Pivotal Software or Apache ActiveMQ. Other message brokers or message-oriented middleware and messaging protocols suitable to implement the examples described herein will be known to those skilled in the art. Further, as those skilled in the art appreciate, message queuing or publish-subscribe protocols generally rely on an address or identifier that is used by endpoints to publish or subscribe to messages. In MQTT, the address or identifier is referred to as a topic, whereas in AMQP, the identifier is a routing key. In the examples described herein, the information used for addressing a broker-mediated message between endpoints is referred to as a “topic”.

The devices 100 may also communicate directly with each other, i.e., bypassing an external message broker system 70, either by using message broker functions executing on individual devices 100, or by using another protocol for device-to-device communication. For these direct communication purposes, the devices 100 may access a routing table 60 to obtain the IP addresses or other network addresses of the other devices 100.

At least one, and more likely several, routing tables 60 are stored in the data network. These routing tables store network addresses for devices 100 and are intended to facilitate device-to-device communication without need for external message broker systems 70. Thus, they need not be stored in the distributed ledger, or be accessible to the endorsing peer systems. Indeed, preferably to protect device privacy, the routing tables and device IP addresses are not stored in the distributed ledger and are only accessible by devices 100 with sufficient credentials or attributes. The routing tables 60 may be hosted by a cloud service provider at different geographical locations to facilitate access by various deployed devices 100, regardless of their physical location, to help reduce latency and avoid a single point of failure should one of the routing tables become inaccessible. Access to the routing tables 60 is discussed further below.

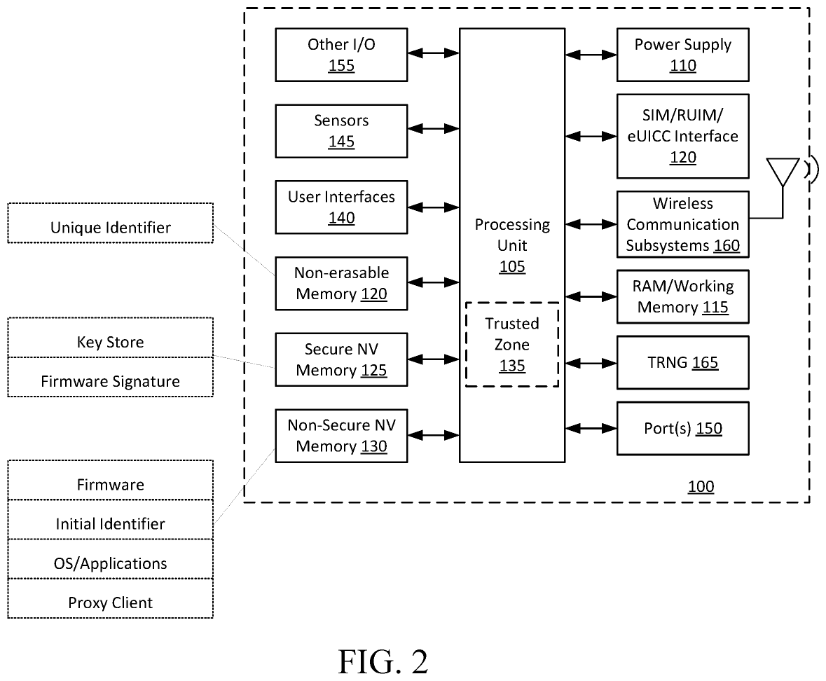

An example configuration for a deployed device 100 is shown in FIG. 2. This figure is a schematic depicting possible functional components of a generic device 100 equipped with communication and sensor functionality. The deployed devices 100 are “smart” or sensor devices, autonomous vehicles, and the like, employing one or more microprocessors, memory, and other elements typical of computing and communication devices. These devices are also suitably configured for communication over fixed and/or wireless connections for direct and/or network communications, appropriate for the intended deployment environment. It will be appreciated by those skilled in the art that deployed devices 100 in the device network can range from single-purpose devices, such as a thermostat or light fixture, to vehicles or complex machines with multiple sensors and control systems, such as motor vehicles (cars and trucks) and aerial drones. While FIG. 2 illustrates select functional elements of a deployed device 100, those skilled in the art will appreciate that a given device 100 may include fewer elements than those depicted in FIG. 2, or may include more functional elements. A device 100 is not limited to a terrestrial device. Not shown are other elements characteristic of specific types of devices 100, such as motors or engines, steering systems, propulsion systems, and so on. Some or all of the example configuration of FIG. 2 may also apply to a distributed ledger node 30, which, like the device 100, is configured for network communications and for accessing a message broker system 70 in order to exchange information with deployed devices 100, and possibly other nodes 30 of the distributed ledger network 10.

The device 100 includes a processing unit, such as a microprocessor 105. Preferably, for enhanced security, the processing unit 105 includes a trusted zone, referred to below as a trusted execution environment or secure processing environment, or SPE. The SPE can perform root of trust measurements and execute attestation, identity, and cryptographic functions. The SPE is distinct from a non-secure processing environment also residing in the device 100, which typically houses data applications and the device operating system. Functions executing in the non-secure processing environment may, however, call secure functions that execute in the SPE. The SPE may be used to boot the device 100, so that a measurement root of trust process can take measurements of firmware code (e.g., SHA-1 hashes) to verify its trustworthiness before passing control of the device 100 to the remaining firmware code and operating system code. Implementation of a SPE will be understood by those skilled in the art. An example is provided by Arm TrustZone™, implemented in processors available from Arm Limited.

The processing unit 105 may also include a hardware true random number generator component (TRNG), or the TRNG may be included as in the device 100 in a separate integrated circuit 165. The device 100 in this example also includes a power supply 110 (e.g., mains power or battery); volatile memory 115; non-volatile memory, in this example non-erasable memory 120, secure non-volatile memory 125 (this may form part of the SPE), and non-secure volatile memory 130. The secure memory 125 may be used to store the client device's key store, in particular the client device's own private asymmetric key(s), and optionally its own and other devices' public keys, although these public keys may be maintained in a key store in the non-secure memory 130. The secure memory 125 also stores communication, security, and other policies provisioned on the device 100 during onboarding or subsequent updates. Trusted application data may also be stored in this secure memory 125. The non-secure memory 130 may store the device firmware, the operating system or other device applications such as publisher and subscription modules for accessing message broker systems 70. A signature or cryptographic hash of the firmware may be stored in the secure non-volatile memory 125 for verification purposes.

The device 100 itself may host broker system functions in addition to acting as a client publisher or subscriber to an external message broker system, in which case software for implementing the broker system may be stored in the memory 130 as well.

Depending on the purpose of the deployed device 100, the device may be provided with various user interface mechanisms 140, such as, but not limited to a display screen, touchscreen, switches, buttons, touchpads, keypads, and so on. Some client devices have minimal interfaces and may only be equipped with simple controls or interfaces, such as an on/off button, and perhaps a visual or audible signal generating means such as a light-emitting diode (LED) indicator or speaker. The device 100 may also be equipped with one or more sensors and location subsystems 145, such as a global positioning system module, an accelerometer, thermometer, ambient light sensor, microphone, camera, and the like. These sensors or subsystems may be used to generate operational or sensor data that is used to control other device functions, or for distribution to others. The device 100 may also include various other input/output subsystems 155 and network and/or data ports 150, such as Ethernet and USB ports. Access to various peripherals and sensors on the device is determined by access control policies stored in the secure memory 125 and enforced by the SPE of the device 100.

The device 100 may be provided with one or more wireless communication subsystems 160 adapted for communication over a network or direct link using one or more protocols, including W-Fi™, Bluetooth™, near-field communication (NFC), Zigbee™, and the like. In some implementations, the device 100 is configured to communicate over a cellular network or using a satellite link, and would be equipped with a suitable radio communication subsystem. Frequently, access to a cellular network requires an association of the communication device 100 with a subscriber of the cellular network service. Thus, the communication device 100 may include an identity module, such as a Subscriber Identity Module (SIM), Removable User Identity Module (RUIM), an embedded Universal Integrated Circuit Card (eUICC), or an embedded SIM (eSIM) as represented by SIM/RUIM/eUICC interface 120. In some implementations, SIM functionality may be built into the processing unit 105 (e.g., an integrated SIM (iSIM), available from Arm Limited.

As mentioned above, the nodes 30 of the distributed ledger network 10 may be organized into different channels associated with specific functions, in which different sets, or even the same sets, of endorsing peers or nodes 30 participate. As those skilled in the art will understand, each channel comprises its own transactions and associated resources, such as chaincode and off-chain storage. Allocation of peers to various channels for a given device swarm or ecosystem may be carried out by the distributed ledger network 10 creator, who in fact may be an administrator of every channel for the device swarm. Once created with an initial set of governance rules for the distributed ledger, further changes to the distributed ledger network 10 (e.g., addition of further peers, changes to governance rules) will be subject to any consensus mechanisms defined for the distributed ledger. The network creator may be the operator of this distributed ledger network 10 and other distributed ledger networks for other device swarms or ecosystems, in which case they may also operate as a billing entity, charging participants (e.g., other stakeholder entities, in particular the enterprise and/or the OEM, and the operators of data plane services associated with the device swarm). The consumption of services may, in some instances, be metered by the billing entity by monitoring the number of transactions invoked on the distributed ledgers on behalf of each stakeholder entity. Billing functions may be implemented using a cryptocurrency managed by the distributed ledger as well.

One example of a distributed ledger channel that may be implemented in the example of FIG. 1 is an attestation channel, which is used to execute functions and services supporting the root of trust of the deployed devices 100. Peer members of this channel operating the participating nodes 30 can include the network operator or billing entity; the OEM of the deployed devices 100, which likely supplies firmware for execution by the devices 100; if relevant, a safety, security or standards certification authority that evaluates and provides certification of the hardware or firmware; and the chip manufacturer, distributor or programmer or OEM who provides the root of trust for the devices 100. In some implementations of the attestation channel, the enterprise may be a peer member, for example in the case where the enterprise is a government authority. Where the enterprise (i.e., the user administration authority) is actually an individual user, as in the case of a consumer device 100, they likely would not participate in this channel.

The endorsing members of the attestation channel may include all or a subset of the aforementioned entities, but in some implementations the network operator/billing entity is omitted as an endorsing member, and simply acts as an administrator of the channel. The network operator may operate the orderer and anchor nodes 30 of the channel, or provide equivalent functions with one or more nodes 30. An attestation channel may be operated to handle the registration of the device root of trust at manufacturing time; register firmware image measurements when the firmware is released; and execute firmware validation functions when a device 100 registers with the distributed ledger network 10.

Another example of a distributed ledger channel is a “device-side” attestation and secure boot management channel. This is referred to as “device-side” since it defines policies for determining the boot state for a device 100, depending on root of trust measurements at the time of boot, or detection of other conditions at the device 100, and also defines accessible functions and memory depending on the state. Thus, for example, the device-side attestation and secure boot management channel may define operational mode, safe mode, and debug modes for the devices 100. Booting into safe mode may be required upon detection that firmware or software has been compromised; in safe mode, firmware-over-the-air (FOTA) updates or agile crypto actions (e.g., changing cryptographic keys) may be permitted to assist the device 100 to return to a known “good” state. Agile crypto functions are also described in PCT Publication No. WO2019/213781, incorporated herein by reference.

Debug mode may require device administrator permission to be triggered, and may permit remote or local access by authorized service personnel (e.g., from the manufacturer). Operational mode is the typical state of the device 100 in which it executes normal data plane functions, e.g., generating sensor data and transmitting data to listeners; communications with other devices, which are preferably encrypted; and execution of untrusted applications, if permitted by device security policies. In safe and debug modes, the execution environment of the device 100 is not permitted access to the cryptographic keys normally used for communications in operational mode (other keys may be stored in the SPE for communications with authorized parties for FOTA and repair purposes), and applications executing outside the SPE may not be granted access to data or keys in the SPE.

Further, in the safe and debug modes, the code executed in the SPE may not permit the device 100 to publish to or access message topics (handled by the message broker systems 70) that are normally permitted during operational mode, effectively removing access by the device to the data plane. Instead, the device 100 may only have access to topics defined specifically for devices 100 when they are operating in safe or debug mode (e.g., topics for communication with a firmware provider for FOTA or for executing agile crypto functions such as cryptographic key replacement). Conversely, while the device 100 is in operational mode, the code executed in the SPE may not permit the device 100 to publish to or access message topics designated for safe or debug mode communications. These communication policies can be defined by the device-side attestation and secure boot management channel participants in the form of message topic definitions, as discussed below.

Another security-related distributed ledger channel that may be implemented is a security lifecycle channel, which is used to define policies and execute functions and services supporting the onboarding of a deployed device 100 as a participant in a device swarm or ecosystem; administrator and user pairings with the device 100, or transferring the device 100 to a new administrator; resetting the device to factory settings, and/or agile crypto functions; and assigning authorized communication topics and attributes for both control and data planes.

Still a further security-related distributed ledger channel that may be implemented is a security monitoring and response channel, which is used to define policies and execute functions and services supporting automated security-related monitoring on the deployed devices 100. Such security policies can include definition of security events (conditions or events at the device that trigger a mitigating response such as event logging, notifications, forcing a change to device security state or boot mode, forcing a connection the attestation channel, forcing a firmware update, restricting access to functions, sensors or connections, and notifications. For example, on a device 100, the SPE may execute a “watchdog” service, monitoring the execution of applications and connections to generate logs for auditing purposes, and to detect anomalous behaviour and trigger a response. An example of anomalous behavior may be a determination that the device 100 has not connected to a control plane-related distributed ledger channel via a related message topic for a specified period of time; this may trigger an agile crypto routine.

Other security-related distributed ledger channels may be directed to monitoring of specific device functions, or specific threat pattern recognition, such as detection of unauthorized access to the device 100, and defining response to these patterns, such as removing all user access to the device 100, resetting the device to factory settings, and re-onboarding the device on the distributed ledger and the device swarm. Some or all of these security-related functions may be combined with the functions of other distributed ledger channels, but it may be desirable in some implementations to maintain separate distributed ledger channels for monitoring these device functions if it is expected that different endorsing peers 30 may participate on these channels, or if different chaincode may be implemented for these functions.

Since the distributed ledger channels comprise distinct ledgers, sharing of information between channels (for example, to enable two devices registered to different channels to communicate) would require an endorsing peer node 30 to be a member of both channels. In some implementations, these endorsing peers may have a higher authority within the channels, permitting them to create rules for cross-channel communication. It is expected that such rules would still require approval by the other endorsing peers of each respective channel. For example, this type of cross-channel communication may arise when different distributed ledger channels are created for device networks differentiated on the basis of security clearance (e.g., commercial, military, secret, top secret), where security clearance represents an attribute stored on deployed devices registered with their respective distributed ledger networks. These levels of security clearance may be defined in a hierarchy (e.g., with top secret being the highest security clearance) Device attributes are discussed in further detail below. Certain peer nodes 30 associated with a higher security clearance, such as top secret, would have higher authority and could create rules to permit communication to take place between distributed ledger channels or devices with different security clearances.

The nodes 30 (i.e., the stakeholder entities) participating as endorsing peers in the first attestation channel may be the same parties participating in the other security-related channels described above; however it will be understood that the set of nodes 30 participating in these different security-related channels may vary. In addition, a cyber warranty provider may also participate as an endorsing peer in the above channels.

Still other channels are directed to the implementation of access control policies, data integrity, and data plane network topology.

An access control channel is used to define access to data plane functions (e.g., message topics, routing tables 60, message brokers 70) based on one or more of device identity, role, and attribute. In the case of message topics, access may be defined on a per-topic basis. The device identity may be defined by a network address, such as IP address, or by a unique identifier such as the UID described in PCT Publication No. WO2019/213781, incorporated herein by reference. Identity-based and role-based access to resources will be understood by those skilled in the art. For privacy reasons, however, it may be preferable to shield the device identity, and to avoid recording transactions in distributed ledgers in the network 10 that identify a device by its unique identifier or network address. In that case, attribute-based access can be implemented. This determines access to message topics based on the current attributes of the deployed device 100. Changes to the access rules stored in the distributed ledger for the access control channel is discussed in further detail below. Attribute-based access may also be advantageous because it may reduce latency in executing certain network functions. For example, if access to a message broker system 70 or message topic is determined based on device attributes or other contextual attributes rather than identity, it is not necessary for the device 100 to share its identity when requesting access of the message broker system 70, or for the message broker system 70 to verify the identity of the device 100 when a request for access is received. Furthermore, relying on attribute-based access to message topics can facilitate the collection of inherently anonymized data in a message topic, since device identity is not required for access.

A further data integrity channel may be used to define and enforce message structure and content on a per-topic basis for a data plane service.

The network topology channel defines publish-subscribe and device-to-device communication in the data plane. For example, this channel manages the addition and removal of message broker systems 70; creation of routing tables 60 for storing device IP addresses as described above.

In a consumer device ecosystem, the nodes 30 participating as endorsing peers in the access control, data integrity and network topology channels may include the network operator/billing entity and the device manufacturer, or in some implementations, the device manufacturer alone. In an enterprise ecosystem, the nodes 30 participating as endorsing peers may further include the enterprise (i.e., the business, organization, or governmental authority).

Where multiple types of devices 100 are included in the swarm or ecosystem, as in the case of a smart city, the nodes 30 participating as endorsing peers may include multiple device manufacturers or OEMs.

Governance rules—for instance, the identity of the endorsing peers, and the number of endorsements or the endorsing peers required to add a transaction to the channel's distributed ledger, or other consensus mechanism—are defined for each channel for a given ecosystem. The network operator/billing entity may unilaterally define these governance rules, but in some implementations other stakeholder entities may participate. These governance rules may be defined as chaincode stored in association with the channel's distributed ledger. Once these governance rules are established for the channel, the individual nodes 30 and their associated stakeholder entities can participate in establishment of policies and rules for recording in the channel's distributed ledger.

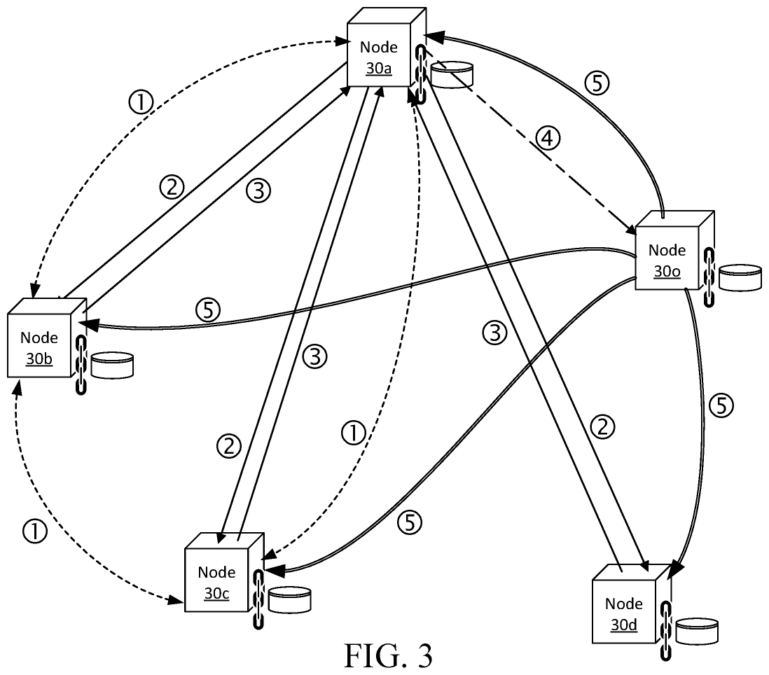

Referring to FIG. 3, an example channel is depicted with participating endorsing peers or nodes 30a-d, each representing a corresponding stakeholder entity such as the network operator, OEM, etc., and an orderer peer 30o. In this example, an anchor peer (such as would be included in a Hyperledger Fabric implementation) is not illustrated. Each of the nodes 30 stores associated chaincode and possibly data outside the distributed ledger. Generally, the establishment of a policy or rule may involve prior communication outside the distributed ledger network 10 between the various stakeholder entities, as represented by communications (1) between various nodes 30a-d. Not every node need participate in these off-network communications, and in fact these communications (1) may not take place at all. An agreement may be reached off the network, at which point one of the participating stakeholder entities, in this example node 30a, transmits (2) a proposed transaction establishing the policy or rule in chaincode to each of the other nodes 30b-d for endorsement, via the distributed ledger network 10. Each of these other nodes 30b-d reviews the proposed transaction to determine whether the proposed chaincode is acceptable. If the off-network communications (1) do not occur, then the first interaction between the node 30a and the other nodes 30b-d concerning this proposed policy or rule is the transmission of the proposed transaction to the other nodes over the network 10. If the other nodes 30b-d approve the proposed transaction, each transmits (3) an endorsement (e.g., the proposed transaction signed by the other node's private key) over the network 10 to the first node 30a. This review and endorsement step may be automated or not.

Once the first node 30a obtains the requisite number of endorsements, it then transmits (4) a request to invoke the transaction, and the endorsements, to the orderer peer 30o. The orderer peer 30o executes chaincode to confirm that the governance rules for the channel's distributed ledger have been met (e.g., verifying the endorsements received from the node 30a). Once this is confirmed, the orderer peer 30o adds the transaction to the distributed ledger, and pushes (5) the new block comprising the transaction to the other nodes 30a-d (or, to anchor peers associated with the participating endorsing nodes 30a-d, as the case may be).

As a specific example, a firmware manufacturer (e.g., OEM) participating in the first attestation channel (e.g., as node 30a in FIG. 3) described above may initially (1) provide their firmware to a certification authority (e.g., a security certification authority), and receive a certification from the authority off the distributed ledger network 10 (e.g., a SHA-1 hash computed for the firmware, signed by the authority's private key). The firmware manufacturer then submits a proposed transaction to add the certification to the channel's distributed ledger to each of the endorsing peers (2). Each of the endorsing peers may verify the certification, for example by verifying the digital signature using the public key of the certifying authority, either included with the proposed transaction or separately obtained by each endorsing peer, and computing the hash independently. A copy of the firmware may be stored in associated storage for the distributed ledger for access by the other endorsing peers. If the certification is verified, the endorsing peer transmits (3) an endorsement to the firmware manufacturer. Once the requisite number of endorsements is received, the firmware manufacturer can then request (4) invocation of a transaction on the distributed ledger by the orderer peer 30o to add the certification, which then adds the transaction in a block on the distributed ledger and transmits (5) the block to the other peers in the distributed ledger channel. The distributed ledger thus stores the certification, which includes the firmware hash, for later retrieval for use in root of trust operations. Since the firmware hash is stored in the attestation channel of the distributed ledger, it may subsequently be used during the onboarding process when a device 100 attempts to self-register with the distributed ledger, as discussed below. The public keys of the certifying authorities and the relevant peers or stakeholders, such as the firmware manufacturer, can also be stored in the attestation channel. This makes the public keys available to the device 100 during the onboarding process so that the device 100 itself can verify the signed certification and the firmware.

In a simpler implementation, the governance rules for the attestation channel may specify that no endorsement is required when a transaction is requested of the orderer peer 300, as long as a valid certification from the certification authority is provided.

A similar procedure may be implemented by the participants of the network topology channel to define a new message broker system 70 or routing table 60 in the device network 20. For example, a message broker system 70 may be instantiated on the network by one of the stakeholder entities participating in the network topology channel (e.g., the network operator or a device manufacturer). The entity, represented in FIG. 3 as node 30a, may omit the off-distributed ledger network communications (1) described above, and initiate the process of adding the message broker system 70 by transmitting (2) a proposed transaction to the other endorsing peers 30b-d defining the broker system 70. For example, the proposed transaction may define the broker system 70 as shown in Table 1, using object notation:

TABLE 1
Example broker definition in object notation.

```
{ broker:
      {
            brokerID: <brokerID>,
            brokerAdmins: [ admin1:<admin1>, admin2: <admin2>,...],
            IPAddress: <addr>,
            location: <location>
      }
}
```

where the broker system 70 is designated with an identifier (brokerID). One or more administrators (brokerAdmins) are also designated. In the case of a message broker system 70 intended for data plane services, the designated administrators may include the device manufacturer, or the provider of the data plane services. In the case of a system 70 intended for use in managing control plane functions, the designated administrators may include stakeholders that participate in the corresponding distributed ledger channels such as the OEM, enterprise, etc. The broker is further defined by its IP address and its geographic location if the control plane allocates deployed devices 100 to message broker systems 70 using a geo-proximity algorithm.

Again, the other endorsing peers 30b-d review the proposed transaction and broker system 70, and if approved, transmit (3) an endorsement to the first node 30a. Once the node 30a has obtained the required endorsements, it then transmits (4) a request to invoke the transaction, and the endorsements, to the orderer peer 30o. The orderer peer 30o executes chaincode to confirm that the governance rules for the channel's distributed ledger have been met (e.g., verifying the endorsements received from the node 30a). Once this is confirmed, the orderer peer 30o adds the transaction to the distributed ledger, and pushes (5) the new block comprising the transaction to the other nodes 30a-d. The channel's distributed ledger thus stores the broker system definition.

A routing table 60, described above, may be instantiated in the device network 20, and its definition added to the network topology channel distributed ledger, in a similar manner. Table 2 sets out an example definition of a routing table that may be implemented in the distributed ledger transaction:

TABLE 2
Example routing table definition in object notation.

```
{ routingTable:
      {
            routingTableID: <routingTableId>,
            routingTableAdmins: [ admin1:<admin1>, admin2:
            <admin2>,...],
            IPAddress: <addr>,
            location: <location>
      }
}
```

In this example, the routing table 60 is identified by an identifier (routingTableID). If the routing table is distributed in multiple locations in the device network 20, then multiple routingTableIDs must be defined. Routing table administrators (routingTableAdmins), the IP address(es), and location(s) are similarly defined as for the broker systems 70.

The definitions of the broker system and routing table may include the broker system's or routing table's public key to permit connection via TLS (Transport Layer Security).

Once at least one message broker system 70 is established in the device network 20, message topics may be defined by the various distributed ledger channels. Depending on the purpose of the distributed ledger channel, the message topics defined by the channel may relate to either control plane functions or data plane functions. For example, in the data plane, a message topic may be defined for sensor data such as all satellite images collected across multiple satellite operators (e.g., both military and commercial), or temperature readings collected by thermostats in a given region. Control plane message topics may include topics to manage attestation of deployed devices 100; device security monitoring; or device boot state.

Whether the topic is defined for use for control plane management or data plane communications, topics are defined according to data type, authoritative message brokers, and access control rules. Table 3 sets out an example abstraction of a topic:

TABLE 3
Example topic definition in object notation.

```
{ topic:
            {
                  topicID: <topicId>
                  topicType: { controlPlane | dataPlane },
                  commType: { brokered | deviceToDevice },
                  blockchainChannel: <channelID>,
                  topicAdmins: [ admin1: <adminID>, admin2:
                  <adminID>,...],
                  brokers : [ { broker1: <brokerID>, broker2:
                  <brokerID>,...],
                  routeTable: [{
                  routeTable1:<routeTableID>,routeTable2:
                  <routeTableID>,...>,
                  shadowRecovery { yes | no }
            }
```

In this example, topics are defined with an identifier (topicID), which is unique to a given publisher. In the case of a data plane topic, the publisher may be a given deployed device 100, an administrative user device (or user device) that publishes messages to the topic, a group of publishers (e.g., the group of deployed devices 100 in an ecosystem that publish to the topic), or a cloud-based application. A node 30 of the distributed ledger network could also be a publisher to a data plane topic; in that case, the message would be published through the execution of chaincode by the node 30 which outputs an event, so that an event listener (e.g., an application executing at the administrator system 35) can detect the event and publish to the topic. In the case of a control plane topic, the publisher would likely be an administrator system 45 of the deployed device, but may also include the stakeholder entities described above, such as a firmware manufacturer, OEM, etc.

In a MQTT or similar implementation, uniqueness of the topic identifier may arise through the selection of an appropriate namespace or routing key as the topicID. For instance, a topicID specific to a given deployed device 100 may include the device identifier in the topic (e.g., deviceID/sensordata or deviceID.sensordata).

The topic may also be described by function (topicType). In the above example, possible options are “controlPlane” or “dataPlane”, defining whether the purpose of the channel is control plane or data plane configuration. Additionally or alternatively, the topic definition may also identify an affiliated distributed ledger channel (blockchainChannel) by identifier (channelID), since the channels are associated with different classes of control plane functions, as described above. Similar channel identifiers may be defined for data plane topics as well. Data plane messages typically comprise telemetry (reporting or receiving sensor data, or other device characteristic/operational data), device configuration data, or actuation messages (operational commands to the device 100).

The topic definition may also expressly define responsible administrators for the topic (topicAdmins, identified by administrator identifier adminID). Optionally, the list of administrators may be omitted if it is implicit in the channel definition (e.g., all endorsing peers of the associated channel are administrators of the topic). In a consumer device network, the administrator of a data plane-related topic may be the OEM, whereas the administrator of a control plane-related topic may be the network creator, billing entity, or consortium of stakeholder entities. In an enterprise device network, additional members of the distributed ledger consortium may be included as administrators of control or data plane topics.

A specific communication type may be assigned to the topic (commType), indicating whether the topic is intended to be handled by one or more assigned message broker systems 70 (brokered), by individual deployed devices 100 executing message broker functions in a mesh network, using device-to-device communications (deviceToDevice). However, commType may be omitted if one of a broker or a routing table is specified, but not the other, in which case the commType by default would be determined to be brokered or device-to-device, as the case may be.

Where message broker systems 70 are used to manage publication and subscription to messages in the topic, the authoritative brokers may be identified in the topic definition (broker) by identifier (brokerID). The brokerID may be an IP address or other network address value. In a device network with multiple message broker systems 70, a subset of message broker systems may be selected based on technical considerations or other constraints. For instance, it may be desirable to expressly allocate messages to specific broker systems in order to minimize message latency for the participants, to balance the load on the brokers in the network, or to ensure that messages are stored at a broker system residing in a specific jurisdiction. In some implementations, it may not be necessary to define the message broker address in the topic definition, if the address is made available to the deployed devices 100 by different means. For instance, in the case of a message broker system deployed by the OEM, the IP address of the message broker system could be encoded in the firmware of the deployed devices 100. In that case, updating the address of the message broker systems would require a firmware update.

In the case where messages may be passed by direct (device-to-device) communication rather than through an external message broker, authoritative routing tables (routeTable) containing network addresses for participating devices 100 may be defined rather than broker addresses. The routing tables may be identified by an identifier such as a uniform resource identifier (routeTableID), and optionally geographical information to permit a device 100 to select a specific routing table.

Finally, the topic definition may include a flag indicating whether a given device 100's status for the topic should be preserved in a device “shadow” or “twin” (shadowRecovery) implemented in a cloud application or other computing system remote from the device 100. A device shadow may be used to store the last-known-good state of a device and/or to buffer requested configuration changes. By storing the last-known-good configuration state of a device, the device shadow can be accessed to restore the device to its last known operational configuration settings in the event the device needs to be reset. The shadow can also store a copy of a received configuration or actuation request (e.g., a request to change a setpoint from an administrator device) as a “requested state” until the device accepts and executes the request, to ensure that received requests are executed in the order in which they were received. In the publish-subscribe model, this device shadow would be a subscriber and publisher to various topics of the physical devices. In this case, the device shadow would have a unique identity linked to the identity of the physical device and associated cryptographic keys to allow the application to verify and sign data. Keys may be stored in a secure vault or SPE, similar to the device 100. Example implementations of a secure vault in a cloud environment include Intel Software Guard Extensions (SGX) and HashiCorp Vault. The secure vault may operate like the SPE of the device 100, receiving and storing access control policies from the distributed ledger as well in a similar manner as the device 100. The device shadow might also have an associated IP address so other connections can be established directly to the device shadow if the physical device is offline. The device shadow would register to the distributed ledger in the same manner as the physical device (without the steps associated with firmware download and update) and may be associated to a device shadow specific distributed ledger channel. This same concept of registering an endpoint cloud application to the distributed ledger can be applied to any other cloud or remote application.

The message structure definition for the topic can include specification of data types and validity ranges. In object notation, a single value may be expressed in the form

[{<varName>:string, <dataType>:string, <validity>:validity,
<validityErr>:handle, <notification>: notification}]

In the case of a data plane topic, the message structure definition determines whether the message comprises telemetry (e.g., sensor data of a deployed device 100) or actuation content (e.g., commands to be executed by a device 100). When the message is directed to the collection or dissemination of telemetry, varName is a variable name for the sensor data; dataType defines the data type (e.g., string vs integer); validity defines a set of one or more conditions for validity; and validityErr defines a function or set of functions to handle an error, triggered by a sensor reading falling outside the validity conditions.

For example, in the case of a thermostat that measures and reports an external temperature, sensor data may be structured as:
[{“OutsideTemp”, “Integer”, {Low: −50, High: +70}, validityErrQ}]

to report the temperature as an integer with a valid range of minus 50 to plus 70 degrees (Celsius), and to call a function validityErr( ) when the sensor detects a temperature outside the valid range. Validity conditions need not be limited to maximum or minimum sensor values; for example, a validity condition may be expressed as a rate of change (e.g., valid changes are <10 degrees per 5 minute period), or as a combination of conditions. Rather than relying on a validity range defined in the message structure, invalid data may also be detected by the device 100 by an application or process executing in the SPE of the device. For instance, a machine learning algorithm executing on the device 100 may be used to detect an anomaly condition based on the sensor readings collected by the device and/or other device conditions such as device temperature (e.g., device overheating), GPS or other location data (device moved from expected location), and ambient light level (direct sunlight, darkness).

In the case when the message is a telemetry message to be sent by the device 100, detection of an invalid value based on the defined validity condition or other determination will trigger the action specified by the validityErr. The action may include dropping the message, and/or dropping the connection to the message broker system 70 or the other device 100 receiving the message; pegging the sensor data to the upper or lower bound, and sending the message; triggering an informational alert or notification for the administrator of the device 100; and/or triggering an alert or notification for the administrator requiring a response (e.g., to approve the invalid value before sending the telemetry message). Alternatively or additionally, the action may include querying other devices 100 in the device network (for instance, other thermostats in the same geographical region, or other temperature sensors deployed in the same local area network or mesh network) to obtain consensus, for example to determine whether all values are the same or within a specified tolerance range. If the values are within the tolerance range, then the sensor value is determined to be valid, and is reported in a telemetry message.

When the message is an actuation message received by the device 100, the varName may describe the type of command (e.g., turn device off/on; timer commands; altering a temperature or other setpoint; programming a scene). The validity range in that case may define upper and lower bounds, or rates of change, for the command. For example, the validity range for a command setting an interior temperature may be ±5, that is to say, a command is valid if it does not alter the current temperature setpoint by more than 5 degrees Celsius. Since actuation commands are typically received from a user, the action specified by validityErr may not be as simple as dropping the message or connection, or pegging the command to an upper or lower bound since it is generally desirable to transmit feedback to the user. A suitable function for handling an invalid value may be a notification to the device administrator that the requested change in an actuation message is outside acceptable limits, and to request confirmation before implementing the command.

With either telemetry or actuation messages, detection of an invalid error may also trigger the creation of a security log on the device 100, which may be periodically published to the distributed ledger network or to other listening devices (e.g., a data plan administrator, the device administrator) for auditing, and possibly resulting in the invocation of agile crypto. Messages containing security log data may be published to a control plane-related topic, for example a security monitoring topic. Additionally, a notification value may be defined in the topic message structure, defining text or information to be saved to the security log or reported in a message when an invalid value is detected.

Message topics and message structure may be defined, endorsed, and added to the distributed ledger in the manner described above with reference to FIG. 3. In the case of data plane topics, the message topics may be defined by the peers of the access control channel, but message structure may be defined by the peers of the data integrity channel, as described above. Control plane topics may be defined by the peers of the relevant channel described above. All changes to these topics and the communication structure are enforced by the secure processing environment on the deployed device 100 and the distributed ledger channel associated with the corresponding security functions. Once a topic and corresponding message structure is established, the topic may be modified by the topic administrator autonomously without necessarily proceeding through the endorsement process described in FIG. 3. Definition of the message topic and structure may include chaincode that may be invoked by or on behalf of the topic administrator to make changes to the topic definition or the message structure definition. The chaincode may limit such changes to certain message structure characteristics, such as validity ranges, or deletion of the message topic altogether. Other changes that may impact the control plane, such as the addition of a new message broker for the message topic, may not be permitted by the chaincode, and instead would require the endorsement process of FIG. 3.

Read and/or write access to message topics hosted by message broker systems 70 by deployed devices 100 may be defined by device or user attribute (collectively referred to as “device attributes”), rather than device identity (i.e., CID) or role in the device network. As mentioned above, use of device attributes to determine access may help shield the privacy of an individual device, since peers in the distributed ledger network 10 do not need to maintain access control lists associating device identifiers with roles or access privileges. Use of attribute-based access also permits access privileges for a given device 100 to be effectively modified in real time based on the current status of the device, without requiring an update to an access control list. In the case of IoT or smart devices, a given device ecosystem may comprise thousands of devices that are unwieldy to manage using identity based access control, or perhaps even role-based access control; the use of device attributes simplifies access control to a more manageable level, since individual devices may autonomously determine whether they are entitled to access a message topic or other resource, or whether their operational state should transition from an operational mode to safe mode or another mode based on their own measurements of their attributes. Attribute-based access may be used in combination with either identity-based or role-based access control, or with both.

Attributes of deployed devices 100 used for attribute-based topic access can include device type, device location, specific network connection, time-of-day, security clearance, certification status, warranty status, and enterprise type (e.g., whether the enterprise deploying the device is an individual consumer, a governmental entity, a commercial entity, etc.). User attributes, which may also be used to determine access to topics, can include a personal certification status, security clearance, credential status (e.g., a professional qualification, driver's license, identity card), personally identifying information such as name, age, or address, data. The user attribute can also include an identity attestation, such as that described in United States Patent Application Publication No. 20190319808A1, published Oct. 17, 2019, which is incorporated herein by reference.

The table below sets out examples of device attributes that may be used to determine access to message topics associated with specific functions. For instance, the type of device (e.g., whether it is a car or motorcycle) may determine whether the device is entitled to have access to message topics used to manage access to a service such as a toll road or parking garage. The message topics in such an example may be used to manage payment of fees and granting access. The device type may also be used to determine access to message topics for vehicle-to-vehicle or vehicle-to-everything (V2V, V2X) communication, for example for the purpose of managing traffic flow and safety.

TABLE 4
Example device attributes.

| Device Attribute | Access |
|---|---|
| Device Type (e.g., car) | Access to facilities such as toll roads, parking garages |
| | Communications with other vehicles, traffic lights, etc. for collision |
| | avoidance, traffic flow |
| Current location | Access to specific facilities based on geographic location, such as |
| | a specific toll road or exit, specific parking garage or building |
| Personally identifying | Access to facilities or vehicles, based on the device user meeting |
| information (e.g., age) | a minimum driver age |
| | Defining a topic validity range, for example a permissible speed |
| | limit or hours of vehicle operation based on driver's age |
| Time-of-day | Access to facilities during a specified contract period, such as |
| | access to a rental car |
| | Defining a topic validity range, for example a permissible nighttime |
| | speed limit |
| Specific network | Access to topics based on type of network connection (e.g., |
| | streaming music over Wi-Fi vs cellular) |
| | Access to devices based on network ID (e.g., military drone may |
| | be operated over specified networks only) |
| | Limit drone operator access to networks with user-to-device and |
| | device-to-user routing latency and throughput properties within a |
| | defined range |
| | Access to specific device controls based on network ID (e.g., limit |
| | access to thermostat temperature setpoint to home's Wi-Fi |
| | network, or same network as thermostat) |

As may be appreciated from the above examples, some device attributes may be measured by the device 100 itself using sensors or other mechanisms, such as current location and time-of-day. Other attributes may only be changed by a device attribute administrator. Where attributes are measured by the device 100, for additional security the data is read by a process executing in the SPE of the device rather than in the non-secure execution environment, to reduce the risk that an untrusted application will tamper with the data used to evaluate access to message topics by the SPE. An entity may be authorized as an administrator of a given device attribute or class of attribute based on the entity's role or the current device state in the manufacturing or security lifecycle. For instance, the individual user or administrator of a device 100, or the IT administrator for devices 100 within an enterprise, may be the authorized administrator of personally identifying information of the user, and may either assign or remove an attribute (e.g., user name, age, address) at any time after the device 100 has been onboarded in the device network 20, and paired with an administrator device. On the other hand, the OEM may be the authorized administrator of other device attributes such as color, make and model (for example in the case of a vehicle), but only at manufacturing time.

Table 5 sets out example classes of attributes and how they may be administered:

TABLE 5
Administrative rights over different types of device attributes.

| | | | Assign/remove |
|---|---|---|---|
| | | | Attribute |
| Attribute Class | Administrator | When | Define attribute |
| Physical and logical | OEM | Manufacturing-time | Color, size, etc. |
| device | | | Time of manufacture |
| | | | Manufacturing batch |
| | | | Device model |
| | | | Software components |
| Device firmware | Component | FOTA-time | Firmware version, |
| | Developer | (SW component | timestamp |
| | | Developer defined) | Trusted measurements |
| Certification | Certification | Certification-time | Certification Lab |
| | Provider | | Certification Level |
| | | | Certification Version |
| | | | Timestamp |
| FOTA | OEM | FOTA-time | FOTA state |
| | | | Requested |
| | | | In-progress |
| | | | Installed |
| | | | Rejected |
| | | | Activated |
| Attestation | Control Plane | At control plane | Hash/sign/version of: |
| | Administrator(s) | access time | Bootloader(s) |
| | Data Plane | At data plane access | Trusted apps |
| | Administrator(s) | time | Untrusted app |
| | | Note: Selection of | RTOS/OS |
| | | specific control plane | Identifiers |
| | | or data plane can be | Device identifier |
| | | attribute-driven | Bootloader identifier |
| | | | Device Security state: |
| | | | Operational mode |
| | | | Debug mode |
| | | | Safe mode |
| | | | Device health (e.g., |
| | | | pass/fail, low/mid/high)) |
| | | | Attestation state |
| | | | Requested |
| | | | Denied |
| | | | Accepted |
| | | Can use for | Attestation timestamp |
| | | attestation expiry | Attestation score |
| | | Old FW component | |
| | | versions can reduce | |
| | | attestation score. | |
| User PII | User | User registration | PII |
| | | | Name |
| | | | Address |
| | | | Age |
| Enterprise Deployment | Enterprise IT | Enterprise | Location |
| | | administration | Building |
| | | | Floor |
| | | | Location |
| | | | Department |
| | | | Team |
| Relationships | Device Admin | Pairing time | Pairing state |
| | | | Requested |
| | | | Paired |
| | | | Rejected |
| | | | Paired state |
| | | | Pairing time |
| | | | Pairing method |
| | | | Pairing location |
| | | | Pairing type |
| | | | Admin to device |
| | | | Admin to user |
| | | | Device to device |
| Security State | Device Monitor | Device security-state | Compromised/ |
| | Cloud Monitor | | uncompromised |
| | | | Security log count |
| | | | (by severity, by recency, by |
| | | | type) |
| | | | Agile Crypto |
| | | | invoked/timestamp |
| | | | Time of last connection to |
| | | | Control Plane |
| Boot State | Boot loader | Device boot mode | Boot state (normal, |
| | | | debug, safe) |
| Warranty | Warranty | Warranty Activation | Warranty provider |
| | Provider | | Warranty status |
| | | | Warranty timestamp |
| | | | Warranty duration |

Attribute-based topic access, and attribute administrator rights as set out above, may be defined and stored in a distributed ledger network 10 in the manner described with reference to FIG. 3 above. Corresponding functions for enforcing access to topics are implemented on the deployed devices 100 when the devices are initially deployed, for example through the installation of device firmware from the OEM, and enforced by the secure processing environment of the devices 100.

In addition, device attributes may serve as an identifier when a device 100 publishes a message to a topic at a message broker system 70. For instance, instead of publishing its telemetry to a message topic that identifies the device by its unique identifier or network address, the device 100 may instead publish its telemetry to a topic that identifies the device only by one or more device attributes (e.g., location, device type, etc.). If the value of a device attribute is variable—such as location, in the case of a mobile device 100, or time-of-day—the message topics created by the device 100 when publishing to the message broker system 70 may be ephemeral, and only persist for the duration of that device attribute value or value range, which is also the duration of the device's access to that specific message topic. In the case of an ephemeral message topic, the publishing device 100 would generate and register a private-public key pair to a distributed ledger channel for this purpose. A subscribing device would obtain the public key from the channel so that it may decrypt the messages obtained from the message broker system 70, or establish an ephemeral symmetric key for communicating with the publisher of a message.

For example, a moving vehicle may join a message broker system 70 at a specific geographic region, enabling it to communicate with other vehicles or road infrastructure in that geographic region; the message topic may be defined by location data. Once the vehicle passes out of that geographic area, it is no longer permitted to communicate using those topics. As another example, a user device 100 may be permitted to communicate with a smart door lock on a dedicated message topic only so long as the current time-of-day corresponds to the user's contract with a vehicle or accommodation rental company.

A device 100 may autonomously determine whether it is permitted access as either a publisher or subscriber to a message topic by executing a function taking device attributes as input, as exemplified in Table 6:

TABLE 6
Example attribute-based access function.

```
{  joinTopicFunction: {
      function: <JoinTopicFunction>, version: <functionVersion>,
      inputParams: [ attr1: <attr1>, attr2: <attr2>, ... ],
      return: {
            publishAccess: { { t | f }, publishValidityRange: <range>,
            subscribeAccess: { t | f }, subscribeValidityRange: <range>
      }
}
```

This function may be executed within the SPE on the device 100. Executing this function on the device 100 minimizes latency, since the function is executed locally without any need for communication with the distributed ledger network 10, and avoids the need to write a transaction to a distributed ledger. Even though the attribute is acted on locally, the attribute-based access control mechanism in the device's secure processing environment is governed by the corresponding distributed ledger channel. Local execution is preferable for time-sensitive communications, such as V2V or V2X communications involving a moving vehicle. However, because the distributed ledger network 10 is not involved, there is no opportunity for a record of the device's access to the topic to be recorded in the distributed ledger, unless the SPE maintains a log that is later uploaded to the distributed ledger network 10 and added in a transaction. As with trusted firmware on the device 100, a (signed) hash of the code comprising the attribute-based access function may be stored on the device 100 and on a distributed ledger so that its integrity can be verified and enforced. This code may be written and signed by a different entity than the firmware manufacturer(s), because the service provider of the service associated with the message topic may be an entity other than a firmware manufacturer.

If latency is less of a concern, the device 100 may request access to a device topic by transmitting a request for a transaction, including its attributes, to an appropriate channel in the distributed ledger network 10. A peer on the network 10 executes chaincode to validate the transaction and to add the result of the access request to the distributed ledger for auditing purposes, and return a response to the device 100 for enforcement by the device's secure processing environment. The response to the device 100 may comprise code for execution by the secure processing environment to provide (or deny) access to the topic. However, where topic access is defined in the device firmware, the response may comprise an instruction to obtain a firmware update in order to gain access to the new topic.

Whether the function is executed locally on the device 100 or in the distributed ledger network 10, it may be invoked manually by the device 100; upon detection of an attribute change at the device (e.g., an updated geographic location); or when the code comprising the function is updated.

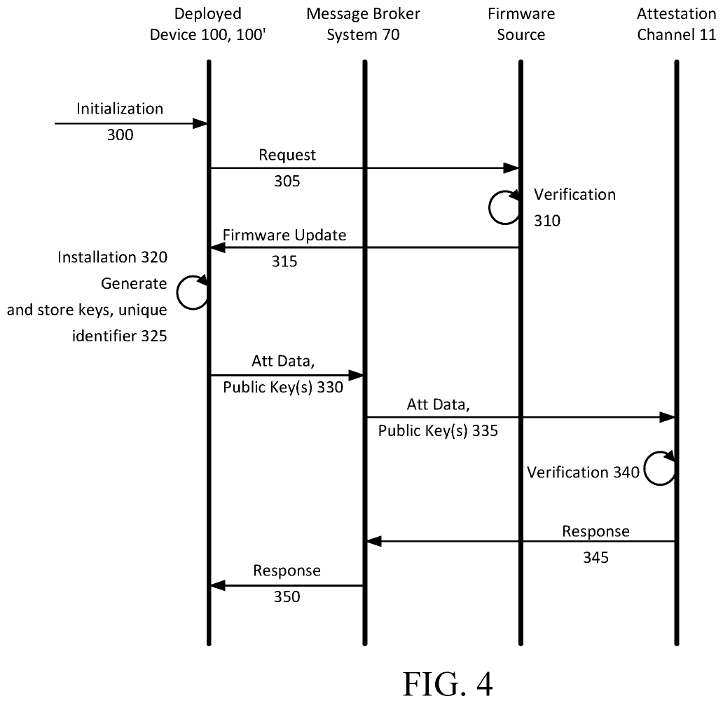

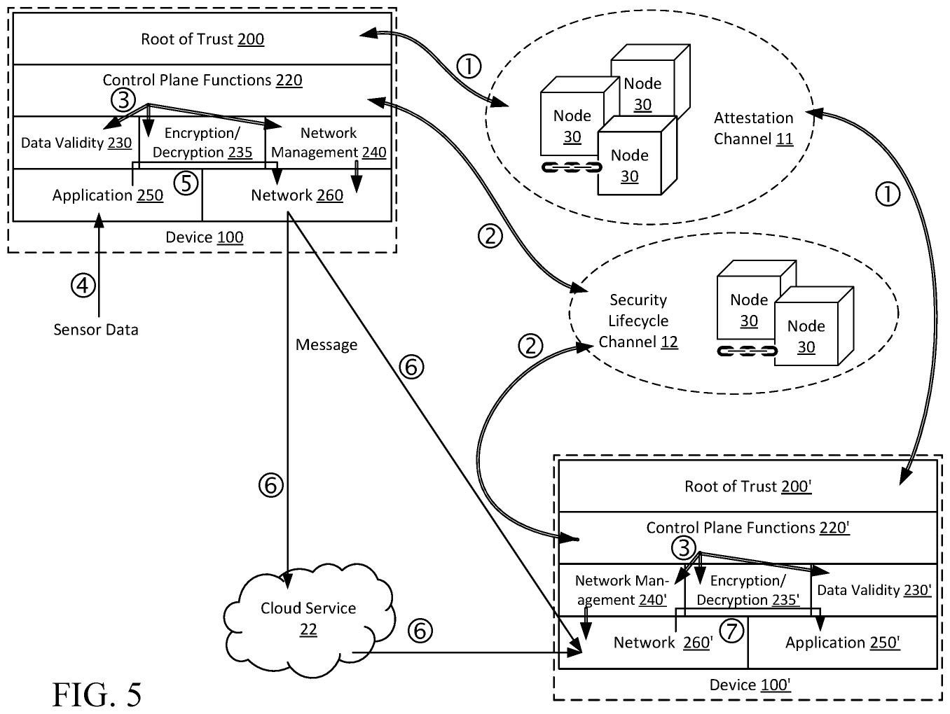

FIGS. 4 and 5 illustrate an example implementation in which deployed devices 100, 100′ are provisioned with access control and security policies defined within the distributed ledger network 10. FIG. 5 schematically depicts select functional modules or layers in devices 100, 100′ (in this example, a first deployed device 100 collecting sensor data and transmitting the data for consumption by a second device 100′) that have been initially provisioned as part of an onboarding process illustrated in FIG. 4. Onboarding of a device 100, 100′ typically occurs when the owner or operator of the device initially receives and activates the device in their own network (e.g., within the enterprise). Referring first to FIG. 4, the device 100, 100′ is first initialized 300, which may include actions such as providing a power source (mains or battery power) and even physical installation steps (where the device 100, 100′ is not mobile or movable). The device 100, 100′, on booting, may check for a network connection before proceeding; in this example, initialization may not proceed further without a wired or wireless Internet connection. With the initial booting, the device 100, 100′ may enter a firmware update mode and contact a firmware source over the network 305 (e.g., as described in United States Patent Application Publication No. 20190319808A1) to request a current version of the required firmware for the device. This request may comprise any information required by the firmware source, such as an initial device identifier (e.g., the device IMEI). On verification 310 of the request by the firmware source, a response 315 comprising a firmware update is sent to the device 100, 100′, or alternatively the device 100, 100′ is permitted to download the firmware, which is then installed 320 by the device. In some implementations, the firmware update is timestamped, and must be installed within a predetermined time after the timestamp to ensure that the firmware is valid. Generally, delivery and installation of the firmware may follow best practices specified by the firmware source (e.g., the OEM), which can include time limitations, encryption policies, digital signatures, etc.

After the installation 320, the device 100, 100′ may generate and store at least one set of asymmetric cryptographic keys 325 for use in encryption/decryption and signing operations. Multiple sets of keys may be generated for different functions (communications vs. identity verification, for example) and/or for use in hybrid encryption algorithms. Additionally, the device 100, 100′ may at this stage generate and store a unique identifier for use in communicating with the distributed ledger network 10. This may be generated from a combination of a random or quasi-random value and the initial device identifier. The unique identifier may be computed as a hash of the combination, with the hash algorithm being identified in the newly-installed firmware. While hashing is not absolutely necessary, this can ensure that the resultant unique identifiers for a given class of device 100, 100′ are of the same length.

Once the unique identifier and the keys are generated, the device 100, 100′ then contacts the distributed ledger network 10, and specifically the attestation channel 11 within the network 10, for example as part of a request for registration on the distributed ledger network. In this particular example, communications between the devices 100, 100′ and the distributed ledger network are mediated by a message broker 70, as shown in FIG. 4. Therefore, communications occur over two stages; first, the sender publishes a message at the message broker 70 using an appropriate topic, and the recipient subscribes to the topic at the message broker 70 and thereby retrieves the message from the topic. The device 100, 100′ is provisioned with the message broker 70's address, and the appropriate topics and message structure information for registration, in the firmware installed on the device. If a message broker 70 is not used, the firmware includes appropriate address and message protocol information for contacting the appropriate node 30. The request for registration 330, 335 in this example includes a report comprising attestation data for the device. This includes measurements of the root of trust 200, 200′ on the device 100, 100′ (as shown in FIG. 5), such as a hash value computed for the device firmware, and can include public keys generated by the device 100, 100′ for use in data plane communications. The request may be signed using an attestation private key that was provisioned on the device during manufacture. A node 30 of the attestation channel 11 (also illustrated in FIG. 5) obtains the request for registration, and can execute chaincode to verify 340 the attestation data against information stored in the attestation channel distributed ledger, such as a manufacturer's identifier for the device, the attestation public key, and firmware hash. This stored information may have been previously added to the attestation channel distributed ledger during device and/or firmware manufacture using the process described above with reference to FIG. 3. If the attestation data is verified, a confirmatory response 345, 350 may be sent back to the device 100, 100′ and the attestation report may be stored in the attestation channel. The attestation data sent by the device may include other attribute data such as telemetry collected by sensors on the device (e.g., location). Verification may be subject to receipt of valid attribute data (e.g., the location of the device must be within a specified geographic area). The node 30 executing the verification of the attestation report received from the device 100, 100′ may add further attestation data derived from the report initially sent by the device. For example, the firmware may have been certified by a security authority, although perhaps unknown to the device, and the certification may be stored in the attestation channel as well. The node 30 may retrieve certification information as part of the verification, and insert it in the attestation report.

In FIG. 5, the registration request including the transmission of root of trust measurements to the attestation channel 11 is depicted by arrows (1) between the respective root of trust 200, 200′ of the devices 100, 100′ and the attestation channel 11. The unique identifier keys received from the device 100, 100′ as part of the registration request 330, 335, may further be shared with one or more other distributed ledger channels in the distributed ledger network 10, such as the security lifecycle channel 12 (not shown in FIG. 4 or 5). Alternatively, after receiving the response 345, 350, the device 100, 100′ may subsequently communicate with a node 30 belonging to the security lifecycle channel 12 to register its identity and public keys directly with that channel 12, as indicated by (2) in FIG. 5. The device 100, 100′ also receives the public keys of the endorsing peers of the attestation channel 11, as well as the public keys of the firmware manufacturer or other source of firmware (if they are not an endorsing peer), for use in verifying subsequent updates to firmware and policies.

The firmware provided to the device 100, 100′ also defines further topics and message structures for other device communications, and other communication, access control and security policies such as selection of encryption and key generation algorithms, permitted network addresses for control plane and data plane communications, and validation rules for determining validity of data (as described above) that is either collected by the device sensors, or received from other devices. Security policies define behaviour of the device in the event that access control policies are not met, Certain parameters or values, such as data validity ranges or values, network and device addresses, message topic definitions, message topic cryptographic keys, and attribute values, may be stored in secure storage 125 on the device 100, 100′. Thus, control plane functions 220, 220′ of the devices 100, 100′ are provisioned as part of the onboarding process, and the SPE of the devices uses this to manage (3) the network functions 240, 240′, cryptographic functions 235, 235′ and data validity functions 230, 230′. Changes to the control plane functions may be provided through firmware updates. Typically, control plane logic is updated by firmware updates, but changes to access control policies, parameters or values, such as data validity ranges or values, network and device addresses, topic cryptographic keys, and attribute values, may be updated by the control plane without a firmware update, by transactions invoked by one or more stakeholders on the distributed ledger. The updates can then be retrieved by individual devices 100, 100′ from the distributed ledger via the message broker system 70 as described above, then stored in secure storage 125 on the device 100, 100′, for example in response to an instruction message received in an associated message topic. These changes, as well as firmware updates, are added to the attestation channel of the distributed ledger in a manner similar to that described above for firmware. When the device 100, 100′ obtains an update, such as a firmware update, from a source other than the distributed ledger, for added security the device may measure the incoming firmware image (e.g., compute its hash) and verify with the attestation channel whether the firmware image was registered on the distributed ledger. The device may obtain a copy of the firmware hash from the attestation channel, signed by all the endorsing peers. The device can then verify the signatures. If a signature cannot be verified, the update is not installed by the device.

FIG. 5 further illustrates how the control plane functions control data plane functions executed by the devices 100, 100′. In this example, an application at the first device 100, represented by the application layer 250, collects sensor data (4). The application collecting sensor data is considered a device application as opposed to a network client application. A device application generates or consumes data that would typically be transmitted in a data plane message, defined above. Such data comprises telemetry, device configuration data, or operational commands. The device application may execute either within the SPE, or in the non-secure portion of the execution environment of the device. The data then passes through the SPE (5) before transmission to a recipient. The data is passed to the SPE where data validation functions 230 may be executed to determine whether the data is valid and to groom the data, if desired. As noted above, validation rules are stored in secure storage 125 on the device 100, 100′. Thus, unlike other IoT implementations, device data such as sensor data is inspected within the device itself rather than by relying on an outside component (such as a hub or server external to the device 100, 100′), which additionally protects device data from unauthorized users (e.g., if the external hub or server were compromised). Valid data may be passed through without alteration to the cryptographic module 235 for encryption; depending on the rules implemented by the control plane, invalid data may be rejected or may be modified in some manner (e.g., a data value outside a valid range may be clipped so that it is within the range, or a flag may be set in the data to indicate its invalidity) before it is passed to the cryptographic module 235. The data is then encrypted, then relayed to the network management module 240 for identification of destination addresses for the message comprising the sensor data, before it is relayed to the network layer 260 for transmission to a recipient. In this example, the sensor data is packaged into a message (6) that can be sent either to a cloud service 22 (e.g., a message broker 70 in the data plane, or other destination service), which relays the message to the recipient device 100′, or else sent directly to the recipient device 100′ in a point-to-point communication. The transmitting device 100 may have obtained the public key for the recipient device 100′ for encrypting the data to be sent to the recipient device 100′ from the distributed ledger via a message broker 70 or alternatively through direct device-to-device communication.

When the message is received at the recipient device 100′ at the network layer 260′, the message is passed (7) to the cryptographic module 235′ for decryption, and the decrypted message is then passed to the data validity module 230′ for validation against any data validity rules enforced by the SPE of the receiving device 100′ (which may be the same as, or different from, the rules enforced at the sending device 100′) before passing the data to the application layer 250′ for processing. This provides separation between the network layer and application layer such that automated control plane functions executing in the SPE can validate a device 100, 100″s data and connections locally on the device without requiring external processing, which may require bridging communications between the device and an external network component. Since access to the device 100, 100′ is determined by the policies enforced by the SPE, and the policies are defined in the distributed ledger, a third party attempting to access to the device must access the distributed ledger and be able to alter the policies registered on the distributed ledger, which is not possible without obtaining endorsements from the endorsing peers for the relevant channel. It will also be appreciated from the foregoing that the network client application is prevented from directly passing data to, or receiving data from, the device applications because data passes first through the SPE where it is decrypted or encrypted. Passing the data through the SPE ensures enforcement of communication and access control policies, and minimizes the risk of corruption of data through tampering or unauthorized access.

The examples and embodiments are presented only by way of example and are not meant to limit the scope of the subject matter described herein. Each example embodiment presented above may be combined, in whole or in part, with the other examples. Some steps or acts in a process or method may be reordered or omitted, and features and aspects described in respect of one embodiment may be incorporated into other described embodiments. Variations of these examples will be apparent to those in the art and are considered to be within the scope of the subject matter described herein. For example, those skilled in the art will understand that stakeholder entities that do not intend to participate as an endorsing peer in the distributed ledger need not operate a node on the distributed ledger. Instead, they may access the distributed ledger from a client system (not illustrated in the drawings), and may submit transactions to the endorsing peers. As another example, while the example attestation channel described above contemplated a single firmware manufacturer that would obtain certification of their firmware and cause a firmware hash to be stored in the distributed ledger, it is possible that there may be multiple firmware components supplied by the same or different manufacturers and dependencies among these components. In such a case, separate transactions may be invoked by the corresponding manufacturer(s) to add information about the certification and dependencies to the distributed ledger (e.g., the attestation channel).

The data employed by the systems, devices, and methods described herein may be stored in one or more data stores. The data stores can be of many different types of classical and quantum storage devices and programming constructs, including but not limited to RAM, ROM, flash memory, programming data structures, programming variables, and so forth. Code adapted to provide the systems and methods described above may be provided on many different types of computer-readable media including but not limited to classical computer storage mechanisms (e.g., CD-ROM, diskette, RAM, flash memory, computer hard drive, etc.) that contain instructions for use in execution by one or more processors to perform the operations described herein. The media on which the code may be provided is generally considered to be non-transitory or physical.

Computer components, software modules, engines, functions, and data structures may be connected directly or indirectly to each other in order to allow the flow of data needed for their operations. Various functional units have been expressly or implicitly described as modules, engines, or similar terminology, in order to more particularly emphasize their independent implementation and operation. Such units may be implemented in a unit of code, a subroutine unit, object, applet, script or other form of code. Such functional units may also be implemented in hardware circuits comprising custom circuits or gate arrays; field-programmable gate arrays; programmable array logic; programmable logic devices; commercially available logic chips, transistors, and other such components. As will be appreciated by those skilled in the art, where appropriate, functional units need not be physically located together, but may reside in different locations, such as over several electronic devices or memory devices, capable of being logically joined for execution. Functional units may also be implemented as combinations of software and hardware, such as a processor operating on a set of operational data or instructions.

Use of any particular term should not be construed as limiting the scope or requiring experimentation to implement the claimed subject matter or embodiments described herein. Any suggestion of substitutability of the data processing systems or environments for other implementation means should not be construed as an admission that the invention(s) described herein are abstract, or that the data processing systems or their components are non-essential to the invention(s) described herein.

A portion of the disclosure of this patent document contains material which is or may be subject to one or more of copyright, design, or trade dress protection, whether registered or unregistered. The rights holder has no objection to the reproduction of any such material as portrayed herein through facsimile reproduction of this disclosure as it appears in the Patent Office records, but otherwise reserves all rights whatsoever.

1. A system, comprising:
a distributed ledger implemented on a plurality of computer systems comprising distributed ledger nodes, each node corresponding to a stakeholder entity;
a plurality of devices configured for network communication, each device comprising a processing unit including a secure processing environment and a non-secure processing environment; and
a message broker system in network communication with at least one computer system of the plurality of computer systems and the plurality of devices for mediating communications between the plurality of devices and the distributed ledger, wherein messages between the at least one computer system and the plurality of devices are associated with a first set of one or more message topics and messages between individual devices of the plurality of devices are associated with a second set of message topics,
the secure processing environment of each of the plurality of devices storing executable code and data,
the executable code including code executable in the secure processing environment of the device for enforcing communication policies, access control policies and security policies, the communication policies defining conditions for permitting the device to access selected message topics at the message broker system,
wherein the communication policies are defined and stored in the distributed ledger by one or more of the plurality of computer systems, and transmitted to the plurality of devices.

2. The system of claim 1, wherein the secure processing environment of each of the plurality of devices further comprises executable code and data for performing root of trust measurements on the device for transmission to at least one of the plurality of computer systems, and each device is configured to transmit the measurements to at least one of the plurality of computer systems for verifying the measurements against information stored in the distributed ledger.

3. The system of claim 2, wherein the measurements and the information stored in the distributed ledger comprise a hash value computed for firmware of the device.

4-5. (canceled)

6. The system of claim 1, wherein the access control policies define access to at least one of data plane functions, sensor data, untrusted applications, cryptographic keys, or device data based on a current boot state of the device.

7. The system of claim 6, wherein the access control policies are defined and stored in the distributed ledger by one or more of the plurality of computer systems, and transmitted to the plurality of devices.

8. The system of claim 1, wherein the executable code includes data validation rules for validating device data generated or received at the device, the device data comprising at least one of telemetry, operational commands, or configuration data for the device.

9. The system of claim 8, wherein the data validation rules are defined and stored in the distributed ledger by one or more of the plurality of computer systems, and transmitted to the plurality of devices.

10. The system of claim 1, wherein the communication policies comprise rules granting access to message topics based on at least one user or device attribute, wherein the at least one user or device attribute comprises at least one device attribute measurable by the device by execution of a process in the secure processing environment.

11. (canceled)

12. The system of claim 1, wherein each device is configured to receive the communication policies and verify with the distributed ledger that the communication policies were registered on the distributed ledger prior to installing the communication policies.

13-15. (canceled)

16. The system of claim 1, further comprising:
an endpoint application executing on a server remote from the device, the server comprising a processing system including a secure processing environment,
the message broker system for mediating messages between the endpoint application and one or more of the at least one computer system of the plurality of computer systems, or the plurality of devices,
the secure processing environment of the endpoint application storing executable code and data, the executable code including code executable in the secure processing environment of the endpoint application to access selected message topics at the message broker system,
wherein the communication policies are transmitted to the endpoint application.

17. A communication method implemented in a device configured for communication over a network, the device comprising a processing unit including a secure processing environment and a non-secure processing environment, the method comprising:
generating device data comprising at least one of telemetry, operational commands, or configuration data for the device in either the non-secure processing environment or the secure processing environment of the processing unit;
validating the generated device data using a data validity module executing in the secure processing environment;
encrypting and/or digitally signing the validated data using a cryptographic module executing in the secure processing environment;
addressing a message comprising the validated data to a destination using a network management module executing in the secure processing environment; and
transmitting the addressed message to the destination using a network client application executing on the device.

18. The communication method of claim 17, wherein generating the device data in the non-secure processing environment comprises executing an application in the non-secure processing environment.

19. The communication method of claim 18, wherein validating the data comprises:
evaluating the generated device data with respect to a valid range of values or detection of an anomaly condition, or
evaluating the generated device data with respect to a valid range of values or detection of an anomaly condition, and clipping the data to an upper or lower bound of a valid range of values when the generated device data is outside the range.

20-22. (canceled)

23. The communication method of claim 19, wherein data validity rules are associated with a message topic at a message broker system, the method further comprising the device subscribing to the message topic and receiving the data validity rules, the data validity rules being applied by the data validity module.

24. (canceled)

25. The communication method of claim 19, further comprising:
the network client application receiving an encrypted and/or digitally signed message over the network;
decrypting the message using the cryptographic module executing in the secure processing environment, if the message is encrypted;
validating data in the decrypted message using the data validity module executing in the secure processing environment; and
passing the validated data to a device application executing in either the non-secure processing environment or the secure processing environment.

26-28. (canceled)

29. An electronic device comprising a processing unit including a secure processing environment and a non-secure processing environment and at least one communication subsystem for network communication, the processing unit being configured to implement:
generating device data comprising at least one of telemetry, operational commands, or configuration data for the device in either the non-secure processing environment or the secure processing environment of the processing unit;
validating the generated device data using a data validity module executing in the secure processing environment;
encrypting and/or digitally signing the validated data using a cryptographic module executing in the secure processing environment;
addressing a message comprising the validated data to a destination using a network management module executing in the secure processing environment; and
transmitting the addressed message to the destination using a network client application executing on the device.

30. A non-transitory computer-readable medium storing code which, when executed by a processing unit of a device including a secure processing environment and a non-secure processing environment, causes the device to implement:
generating device data comprising at least one of telemetry, operational commands, or configuration data for the device in either the non-secure processing environment or the secure processing environment of the processing unit;
validating the generated device data using a data validity module executing in the secure processing environment;
encrypting and/or digitally signing the validated data using a cryptographic module executing in the secure processing environment;
addressing a message comprising the validated data to a destination using a network management module executing in the secure processing environment; and
transmitting the addressed message to the destination using a network client application executing on the device.

31. The electronic device of claim 29, wherein generating the device data in the non-secure processing environment comprises executing an application in the non-secure processing environment, and wherein validating the data comprises:
evaluating the generated device data with respect to a valid range of values or detection of an anomaly condition, or
evaluating the generated device data with respect to a valid range of values or detection of an anomaly condition, and clipping the data to an upper or lower bound of a valid range of values when the generated device data is outside the range.

32. The electronic device of claim 29, wherein the processing unit is further configured to implement, when the network client application receives an encrypted and/or digitally signed message over the network,
decrypting the message using the cryptographic module executing in the secure processing environment, if the message is encrypted;
validating data in the decrypted message using the data validity module executing in the secure processing environment; and
passing the validated data to a device application executing in either the non-secure processing environment or the secure processing environment.

33. The non-transitory computer-readable medium of claim 30, wherein generating the device data in the non-secure processing environment comprises executing an application in the non-secure processing environment, and wherein validating the data comprises:
evaluating the generated device data with respect to a valid range of values or detection of an anomaly condition, or
evaluating the generated device data with respect to a valid range of values or detection of an anomaly condition, and clipping the data to an upper or lower bound of a valid range of values when the generated device data is outside the range.

34. The non-transitory computer-readable medium of claim 30, wherein the device is further caused to implement, when the network client application receives an encrypted and/or digitally signed message over the network,
decrypting the message using the cryptographic module executing in the secure processing environment, if the message is encrypted;
validating data in the decrypted message using the data validity module executing in the secure processing environment; and
passing the validated data to a device application executing in either the non-secure processing environment or the secure processing environment.
